(19) United States
(12) Patent Application Publication
(10) Pub. No.: US 2006/0154205 A1
(43) Pub. Date: Jul. 13, 2006

(54) Dental implants with improved loading properties

(75) Inventor: John A. Reggie, Menlo Park, CA (US)

Correspondence Address: O'MELVENY & MYERS LLP, 610 NEWPORT CENTER DRIVE, 17TH FLOOR, NEWPORT BEACH, CA, 92660, US

(73) Assignee: Dynamic Implants

(21) Appl. No.: 11/328,815

(22) Filed: Jan. 9, 2006

Related U.S. Application Data
(63) Continuation-in-part of application No. 11/035,312, filed on Jan. 12, 2005.

(51) Int. Cl. A61C 8/00

(52) U.S. Cl. 433/173; 433/176

(57) ABSTRACT

A dental prosthetic includes an elongate threaded implant adapted to be secured within the trabecular region of a maxilla or mandible. An abutment having a first region adapted to receive a crown and a second region adapted for coupling to the elongate threaded implant is secured to the elongate threaded implant. The abutment and elongate threaded implant extend generally along a common longitudinal axis. A compliant brace is adapted for placement between the first region of the abutment and the elongate threaded implant. The compliant brace includes first, second, and third elongate extensions capable of engaging the cortical region of the maxilla or mandible, thereby minimizing micromotion and allowing for osseointegration despite immediate installation of a crown and immediate mechanical loading. The dental prosthetic may also include an adaptor for coupling the elongate threaded implant and the abutment. Methods for implanting dental prosthetics are also described.

This is a continuation-in-part of U.S. application Ser. No. 11/035,312, filed Jan. 12, 2005, which is expressly incorporated herein by reference in its entirety.

### FIELD OF THE INVENTION

The invention relates to devices and methods for replacing teeth with dental implants.

### BACKGROUND

Traditionally, dentures or bridges are used to treat patients who have lost some or all teeth on their upper jaw (maxilla) or lower jaw (mandible). A reparative option that is gaining popularity is the use of a dental implant with a prosthetic crown attached above the gumline. The implants can also be used in patients having damaged teeth, such as malformed or malpositioned teeth. These implants, usually made of titanium, are screwed into the jawbone after a receiving hole is drilled into the bone.

There are two general classifications of bone—trabecular and cortical. Cortical bone is a dense, hard, and stiff material that makes up the outer surface of bones while trabecular bone is a porous and softer material that makes up the inner core of the bone. Because conventional implants are threaded into the trabecular bone through a hole drilled through the cortical bone, much of the load is transferred from the prosthetic tooth, through the implant, and to the surface between the implant and the trabecular bone. Unfortunately, trabecular bone may not have adequate thickness and strength to keep micromotion below the required level before the two surfaces have grown together.

A disadvantage of current implant systems is that patients often have to wait for a duration of three to six months or more to avoid mechanical loading the implants (as in chewing) to allow bonding by ingrowth into surface crevices of the implant, i.e., osseointegration. Movement between the implant and the bone (commonly known as “micromotion”) can cause formation of a layer of fibrous tissue between the implant and the bone and prevents optimal bonding between the two surfaces. It has been shown that micromotion must be kept below 50 to 150 micrometers to allow growth between the implant and the trabecular bone.

Therefore, new tooth prosthetics are needed that will permit osseointegration and minimize micromotion despite securing a crown at the same time the implant is installed. New prosthetic devices and methods are therefore needed that will allow immediate mechanical loading without waiting for a period of months and still result in successful osseointegration.

### SUMMARY OF THE INVENTION

The present invention relates to dental implants and prosthetic devices that allow for immediate installation of a crown, immediate mechanical loading during use of the implants, and that minimize micromotion during loading to permit osseointegration with the implant despite immediate use. In a first embodiment, the dental prosthetic comprises an elongate threaded implant that is secured within the trabecular region of the maxilla or mandible. An abutment is secured to the elongate threaded implant and is adapted to receive a crown. The abutment and implant may be of a unitary construction or separate components that are secured after implantation. Both the implant and the abutment are generally elongate components. Once secured to the implant, the abutment is typically oriented generally along the same longitudinal axis as the implant. In other embodiments, the axis of the abutment is angled relative to the axis of the implant, generally by one degree or less, two degrees or less, three degrees or less, four degrees or less, five degrees or less, six degrees or less, seven degrees or less, eight degrees or less, nine degrees or less, or ten degrees or less.

A generally flat surface member may be secured to the region where the abutment meets the implant. The flat surface extends generally perpendicular to the axis of the abutment and the implant. The flat surface is typically made of flexible titanium, flexible stainless steel, or other flexible material suitable for use as a dental implant and known in the art. The flat surface is shaped to engage the cortical region of the maxilla or mandible. In certain cases, the flat surface extends to a curved region that engages a vertical surface of the cortical region of the jawbone. In other cases, there will be two curved regions at opposite ends of the flat surface, one to engage an inner vertical surface of the jawbone and the other to engage the outer surface of the jawbone. In still other embodiments, the flat surface includes at least one anchoring element to secure the flat surface to the cortical region of the jawbone. The anchoring element can be located on the flat surface, on one or more curved region, or on both. The anchoring element may comprise a barb or other suitable structure. The generally flat surface may be integral with the implant, integral with the abutment, integral with both, or not integral with either.

In certain embodiments, the portion of the implant that secures the cortical bone, e.g., the generally flat surface, is formed of a compliant material, e.g., elastic titanium or elastic stainless steel that will conform to an irregular surface of the bone. The generally flat surface will have an elastic property that will allow the structure to conform to the bone and form a tight seal against the bone. By forming a tight seal the compliant structure (1) helps reduce the chances of bacterial infiltration between the implant and the bone, and (2) reduces the amount of movement between the bone and implant.

A compliant structure will also allow for small adjustments to be made by rotating the implant. This may be advantageous where, for example, the trajectory of drilling the receiving hole in the bone is not correct to achieve alignment with adjacent teeth. The hole in the implant that receives the abutment may be offset relative to the axis of the implant. Thus, as the implant is rotated, the angle of the abutment relative to the adjacent teeth will adjust. By use of a compliant material for the generally flat surface, the curved region, or “wings,” can be lifted, the implant rotated to achieve the correct angle for the abutment, and the curved region allowed to fall back in place around the bone structure. Here, after rotation, the wings may have to fold along a new line to tightly wrap around the bone structure. Use of a compliant material allows the wings to fold along a new line after the implant is rotated.

Bacterial infiltration can cause bone reduction and degradation. A tight fit is therefore desired between the bone and the flat structure. The curved regions at the ends of the generally flat structure may be biased inwardly to assure the formation of a tight seal with the bone structure. In this manner the curved regions will be pried open, placed over the ridge of the maxilla or mandible, and released to snap down tightly over the maxilla or mandible. In some cases the titanium or stainless steal is cut with thin spots to give strain relief and bending properties. In other cases, the bone structure is ground down to make a flat surface to receive the implant.

In use, the devices described herein function as a replacement for tooth loss. Osteotomy is created by drilling into the maxilla or mandible at the location of the missing tooth. The implant is inserted into position within the trabecular region of the jawbone. Where the flat surface is pre-attached to the implant, the implant is threaded until the flat surface engages the cortical region of the jawbone. In cases where the flat surface is not attached to the implant, the generally flat surface is then attached after placement of the implant so that the flat surface tightly engages the cortical surface. The abutment extends from the jawbone once the implant is in place, or is then attached to the implant. A crown is then secured to the abutment.

In certain cases, the flat surface extends to one or more curved regions that are shaped to engage the inner and outer vertical surfaces of the cortical region of the mandible or maxilla. The curved regions may be elastically deformable and biased inward so as to tightly engage the vertical surfaces of the bone. During installation, the vertical regions are pried apart, placed over the bone, and released to form a tight fit with the bone. In other cases, one or more anchoring elements are placed to engage, and possibly penetrate, the cortical surface of the jawbone.

In a further embodiment, the dental prosthetic comprises an elongate threaded implant, an abutment, and a compliant brace. The elongate threaded implant is adapted to be secured within the trabecular region of a maxilla or mandible. The abutment has a first region adapted to receive a crown and a second region adapted for coupling to the elongate threaded implant. The compliant brace is adapted for placement between the first region of the abutment and the elongate threaded implant and includes a plurality of elongate extensions capable of engaging the cortical region of the maxilla or mandible. In one embodiment, the plurality of elongate extensions include first and second extensions. In another embodiment, the plurality of elongate extensions include first, second, and third elongate extensions.

In use, the dental prosthetic can function as a replacement for tooth loss. Osteotomy is created by drilling into the maxilla or mandible at the location of the missing tooth or by utilizing the socket of the newly extracted tooth. The elongate threaded implant is inserted into position within the trabecular region of the jaw bone. The abutment and compliant brace are then secured to the elongate threaded implant, wherein a portion of the abutment extends beyond the maxilla or mandible. The compliant brace is located between the first region of the abutment that is adapted to receive the crown and the elongate threaded implant. The abutment and compliant brace can be secured to the elongate threaded implant by securing a region of the abutment through an opening of the compliant brace into a region of the elongate threaded implant. This could be accomplished by screwing a threaded region of the abutment through an opening of the compliant brace into a threaded region of the elongate threaded implant. The first, second, and third elongate extensions of the compliant brace are then adjusted to engage the surface of the cortical region of the maxilla or mandible. These extensions can be adjusted by bending or shaping the extensions to conform to the surface of the cortical bone, or, the extensions may be supplied in a pre-bent configuration where they are bent beyond the desired position. The pre-bent extensions could then be re-shaped or “pried” open to fit over the boney ridge. The compliant brace can optionally be further stabilized by anchoring the extensions to the maxilla or mandible. The anchoring element(s) may comprise a barb, bone tack, or other suitable structure. A crown is then secured to the abutment.

In a further embodiment, the dental prosthetic comprises an elongate threaded implant, an adaptor, an abutment, and a compliant brace. The elongate threaded implant is adapted to be secured within the trabecular region of a maxilla or mandible. The adaptor has first and second regions, wherein the first region is adapted for coupling with the elongate threaded implant. The abutment has a first region adapted to receive a crown and a second region adapted for coupling to the adaptor. The compliant brace is adapted for placement between the first region of the abutment and the adaptor and includes first, second, and third elongate extensions capable of engaging the cortical region of the maxilla or mandible.

In use, the dental prosthetic can function as a replacement for tooth loss. Osteotomy is created by drilling into the maxilla or mandible at the location of the missing tooth. The elongate threaded implant is inserted into position within the trabecular region of the jaw bone. An adaptor is secured to the elongate threaded implant. An abutment and compliant brace are then secured to the adaptor, wherein a portion of the abutment extends beyond the maxilla or mandible. The compliant brace is located between the first region of the abutment that is adapted to receive the crown and the adaptor. The abutment and compliant brace can be secured to the adaptor by securing a region of the abutment through an opening of the compliant brace into a region of the abutment. This could be accomplished by screwing a threaded region of the abutment through an opening of the compliant brace into a threaded region of the elongate threaded implant. The first, second, and third elongate extensions of the compliant brace are then adjusted to engage the surface of the cortical region of the maxilla or mandible. These extensions can be adjusted by bending or shaping the extensions to conform to the surface of the cortical bone or the extensions may be supplied in a pre-formed shape. The pre-formed or pre-bent extensions could then be re-shaped or “pried” open to fit over the boney ridge. The compliant brace can optionally be further stabilized by anchoring the extensions to the maxilla or mandible. The anchoring element(s) may comprise a barb, bone tack, or other suitable structure. A crown is then secured to the abutment.

The compliant brace of these prosthetics is typically made from a flexible material such as titanium, stainless steel, or other flexible material suitable for use as a dental implant and known in the art. The compliant brace will have an elastic property that will allow the structure to conform to the bone and form a tight seal against the surface of the bone. By forming a tight seal, the compliant brace helps reduce the chances of bacterial infiltration between the implant and the bone, and reduces the movement between the bone and implant by acting as an additional load-bearing structure. The compliant brace will also allow for small adjustments to be made by rotating the implant and/or changing the angle of the abutment. The thin, elongate extensions will allow the tissue (gingivae) surrounding the missing tooth to grow around between the extensions, thereby reattaching themselves to the jaw bone. This further assists the stabilization of the implant.

The compliant brace may have a generally planar region, wherein the second and third elongate extensions extend from the generally planar region in a direction substantially opposite from the first elongate extension. This planar region may have smooth, rounded edges to enhance soft tissue encapsulation. The generally planar region of the compliant brace may also have an outer region that is generally circular in shape. The compliant brace may also have a generally circular opening in the generally planar region. Optionally, the opening in the generally planar region may be any shape that can be disposed about the second region of the abutment. At least one of the first, second, or third elongate extensions may also have a further anchoring element(s) adapted to secure the first, second, or third elongate extensions to the cortical region of the maxilla or mandible. Additionally, at least one of the first, second, or third elongate extensions may have a hole located along the extension or at the end of the extension in which a bone tack can be inserted to further anchor or stabilize the extension(s) to the cortical bone. Furthermore, at least one of the first, second, or third elongate extensions may have generally rounded edges to enhance soft tissue encapsulation.

### BRIEF DESCRIPTION OF THE DRAWINGS

FIG. 1A depicts a unitary implant with flat surface and abutment.

FIG. 1B depicts the unitary implant of FIG. 1A having anchoring elements.

FIG. 2A depicts the implant of FIG. 1B engaging a jawbone.

FIG. 2B depicts an expanded view of FIG. 2A having an anchoring element penetrating the cortical bone structure.

FIG. 2C depicts an alternative implant structure with anchoring elements disposed to contact the horizontal surface of the cortical bone structure.

FIG. 2D depicts an implant with anchoring elements contacting both horizontal and vertical surfaces of the cortical bone structure.

FIG. 3A depicts an implant having unitary flat surface element and a separate attachable abutment.

FIG. 3B depicts a threaded implant with a separate, unitary abutment and flat surface element attachable to the implant.

FIG. 4A depicts the implant of FIG. 3A engaging a jawbone structure.

FIG. 4B depicts the implant of FIG. 4A after attachment of the abutment.

FIG. 5A depicts the implant of FIG. 3B installed within the trabecular bone structure.

FIG. 5B depicts the installed implant of FIG. 5A having abutment and flat surface element attached.

FIG. 6 depicts an implant having a circular flat surface element.

FIG. 7A depicts an alternative implant.

FIG. 7B depicts a cross section of the alternative implant of FIG. 7A.

FIG. 8A depicts an alternative abutment.

FIG. 8B depicts the alternative abutment assembled with the alternative implant.

FIG. 9A depicts the implant assembly of FIG. 8B implanted in a cross section of a simulated jaw bone.

FIG. 9B depicts the implant assembly of FIG. 8B implanted in another cross section of a simulated jaw bone.

FIG. 10A depicts a cortical bone engagement device (or compliant brace).

FIG. 10B depicts an alternative cortical bone engagement device (or compliant brace) with rounded edges.

FIG. 11 depicts an exploded view of an implant assembly.

FIG. 12 depicts the implant assembly of FIG. 11 implanted in a cross section of a simulated jaw bone.

FIG. 13 depicts an adaptor for use between an abutment and an implant.

FIG. 14 depicts an alternative abutment.

FIG. 15 depicts an exploded view of an alternative implant assembly.

FIG. 16A depicts the implant assembly of FIG. 15 implanted in a cross section of a simulated jaw bone.

FIG. 16B depicts a cross section of the implant assembly of FIG. 16A.

### DETAILED DESCRIPTION

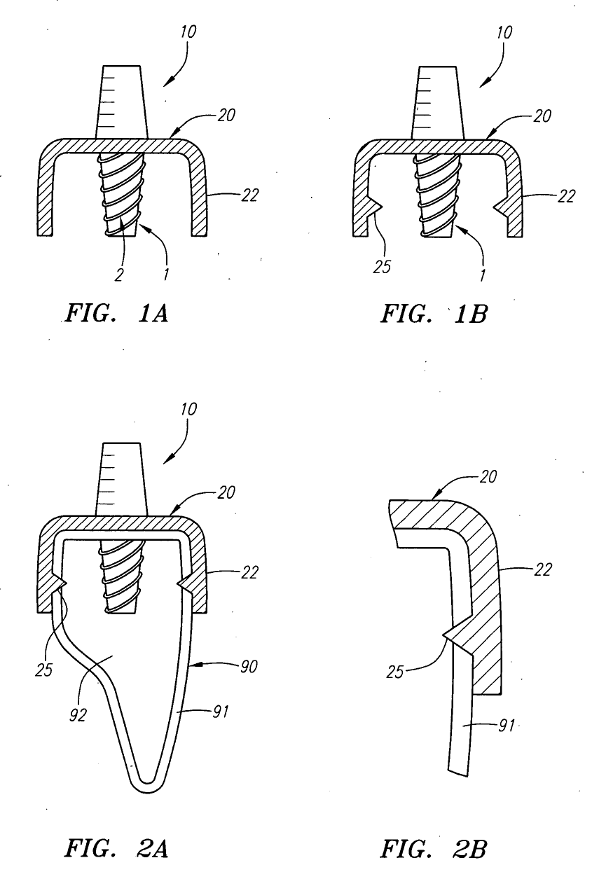

FIG. 1A depicts a first embodiment of the implant described herein. Implant 1 contains threaded region 2 designed to enter and be threaded into the trabecular region of a bone. Abutment 10 extends from one end of implant 1. A generally flat surface, element 20, extends from an intermediate region between implant 1 and abutment 10, and lies in a plane perpendicular to the axis of the implant and abutment. Flat surface element 20 may include curved regions 22, which are shaped to extend along the vertical inner and outer surfaces of the mandible or maxilla. FIG. 1B shows the implant device with anchoring elements, here barbs 25, placed on the inside surface of curved region 22. The implant is typically formed of titanium or stainless steel, but is desirably made of flexible titanium of stainless steel so that it tightly conforms to and engages the cortical surface of the bone structure despite surface irregularities that will be present on the surface even after grinding or filing to remove irregularities.

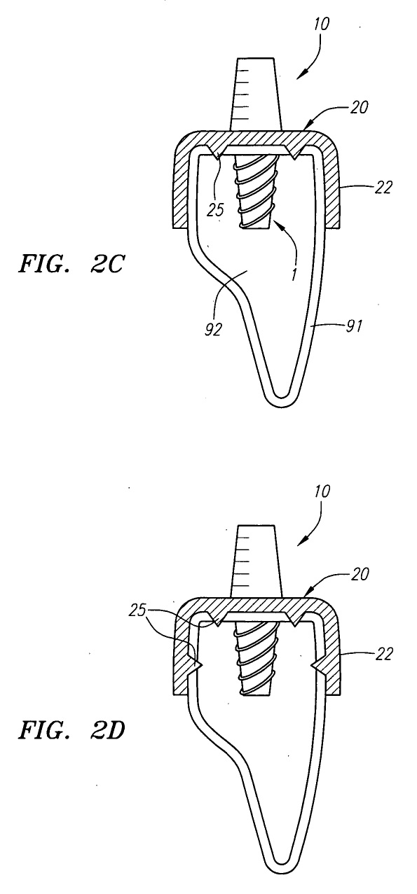

FIG. 2A depicts mandible or maxilla 90, having cortical bone structure 91 and trabecular bone structure 92. Implant 1 extends into trabecular bone structure 92. Abutment 10 extends above bone 90. Flat surface member 20 extends laterally along the horizontal surface of cortical bone structure 91. Curved regions 22 extend along the vertical surface of cortical bone structure 91. Anchoring elements 25 are secured to the surface of cortical bone structure 91. This device minimizes lateral, vertical, and torsional micromotion because flat surface member 20 acts as a brace to secure the implant to the more rigid cortical bone structure, thereby minimizing movement within trabecular bone structure 92. Reduction in micromotion aids the process of osseointegration. FIG. 2B is an expanded version of FIG. 2A showing anchoring element 25 secured to the vertical surface of cortical bone structure 91. FIG. 2C shows anchoring elements 25 secured to the horizontal surface of cortical bone structure 91. FIG. 2D shows anchoring elements 25 secured to both the horizontal and vertical surfaces of cortical bone structure 91.

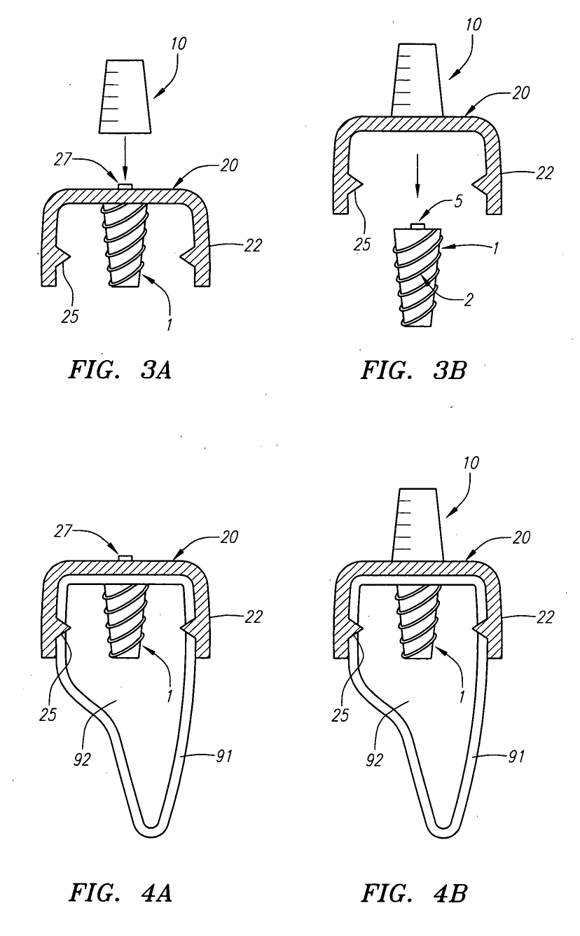

FIG. 3A shows an alternative design of the prosthetic described herein. Threaded implant 1 includes flat surface member 20 and optional curved regions 22 with one or more optional anchoring elements 25. Flat surface 20 includes post 27 for attachment of abutment 10 before or after the implant is secured to the bone structure. It will be understood that curved regions 22, when present, will be deflected away from threaded implant 1 during installation to allow implant 1 to be inserted like a screw into the bone structure. In certain cases, a clip (not shown) holds the curved regions 22 in a position deflected away from threaded implant 1 during installation. After the implant is fully threaded into the bone, curved regions 22 are released (by removal of the clip when present) and snap down to tightly engage the cortical surface of the bone. FIG. 4A depicts placement into a mandible or maxilla bone structure, and FIG. 4B shows attachment of abutment 10.

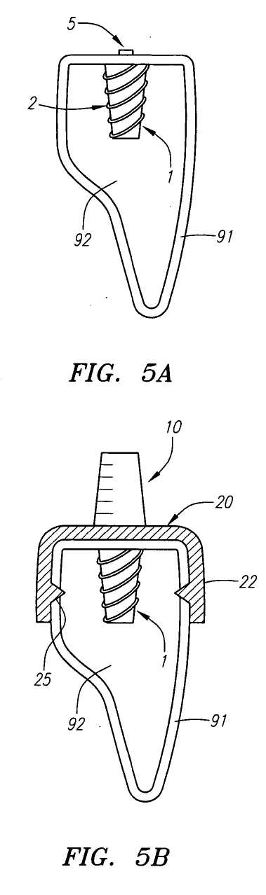

FIG. 3B shows an alternative design of the prosthetic described herein. Threaded implant 1 is first inserted into the bone like a screw into a drilled receiving hole in the bone. Implant 1 includes post 5 for attachment of abutment 10 and flat surface member 20. Abutment 10 and flat surface 20 can be made unitary or of two separate pieces that are attached at the time of surgery. FIG. 5A depicts placement of implant 1 into a mandible or maxilla bone structure, and FIG. 5B shows attachment of abutment 10 and flat surface member 20 with optional curved regions 22 with one or more optional anchoring elements 25.

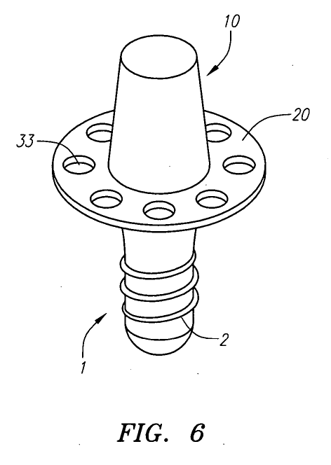

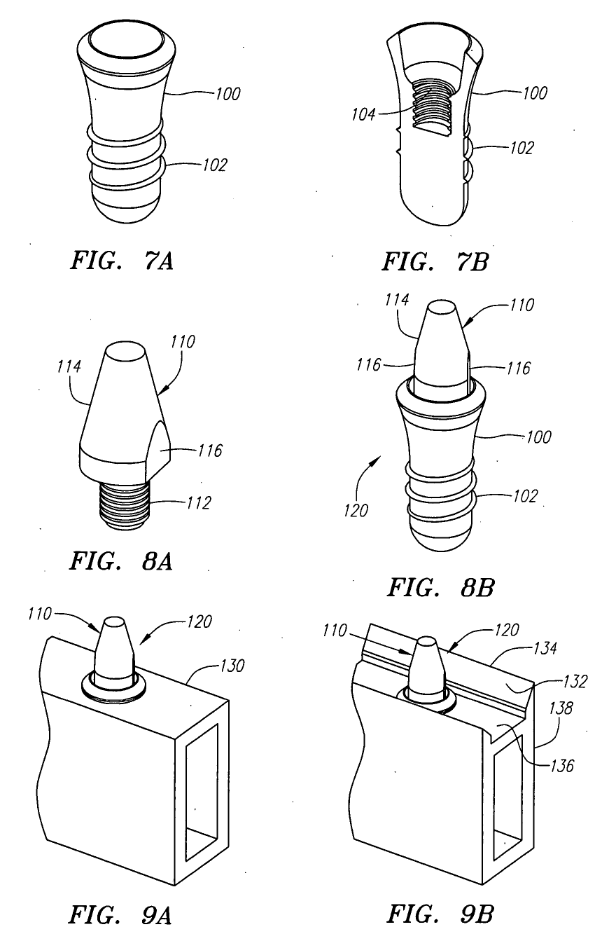

FIG. 6 shows a further alternative design of the prosthetic described herein. Implant 1 contains threaded region 2 designed to enter and be threaded into the trabecular region of a bone. Abutment 10 extends from one end of implant 1. A generally flat surface, element 20, extends from an intermediate region between implant 1 and abutment 10, and lies in a plane perpendicular to the axis of the implant and abutment. Flat surface element 20 is generally circular. This shape allows the implant to be threaded into the bone by any number of turns to achieve optimal insertion. The flat surface can then be bent over the vertical edges of the jawbone. Moreover, the axis of the abutment may be angled relative to the axis of the implant. This way, the placement of the crown can be adjusted to align with the adjacent teeth. Flat surface element 20 may also include one or more holes 33 that allow the gum tissue to maintain contact with the bone and thereby reduce the chance for infection.

FIGS. 7-9 show a further alternative design of the prosthetic described herein. FIGS. 7A-B illustrate a generally elongate threaded implant 100, often called a “root form” implant. Elongate implant 100 has a first threaded region 102 on the outside of the elongate implant adapted to engage the trabecular region of the bone and a second threaded region 104 on the interior of the implant 100. Second threaded region 104 is a female joint adapted to receive and secure a threaded portion of an abutment. Elongate implant 100 is secured into the bone by drilling a receiving hole into the bone and then screwing first threaded region 102 into the receiving hole.

FIG. 8A illustrates an abutment 110 adapted to be mechanically coupled to elongate implant 100. Abutment 110 has a generally elongated region 114 connected to a threaded region 112. In one embodiment, the elongated region 114 may have a conical shape. Abutment 110 may also have one, two, or more flattened regions 116 of the generally elongated region 114 to aid in torquing for placement. Threaded region 112 is adapted to be coupled to the elongate implant 100 by joining threaded region 112 (male joint) of abutment 110 with second threaded region 104 of elongate implant 100 (female joint). Alternatively, the elongate implant may have a threaded male joint that is adapted to be coupled with a threaded female joint of the abutment (not shown). FIG. 8B depicts implant assembly 120 including abutment 110 coupled to elongate implant 100. FIG. 9A illustrates assembly 120 implanted into a simulated jaw bone cross section 130. The jaw bone 130 is meant to simulate a posterior section of the jaw. FIG. 9B illustrates assembly 120 implanted into another simulated jaw bone cross section 132. The jaw bone 132 is meant to simulate an anterior section where the top of the bone ridge is irregular, often in the shape of a “valley,” having a first ridge 134, a second ridge 136, and a flattened region 138. As depicted in FIGS. 9A-B, abutment 110 protrudes beyond the top of the bone crest and the surrounding tissue. Abutment 110 serves as a structural member to which a crown may be attached.

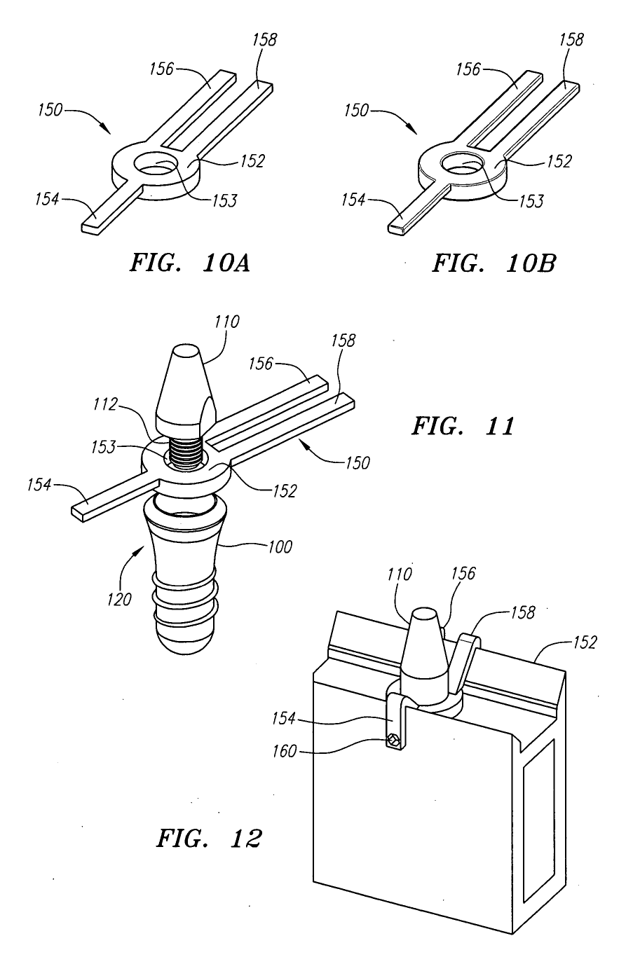

FIG. 10A illustrates cortical bone engagement device or compliant brace 150 having a generally planar portion 152 and three elongate extensions 154, 156, 158 extending therefrom. Generally planar portion 152 has a generally circular opening 153 that is adapted to receive the threaded region of abutment 112 therethrough. In one embodiment, generally planar portion 152 may have an outer region that is generally circular in shape. As seen in FIG. 10B, generally planar portion 152 may also have generally smooth, rounded edges to enhance soft tissue encapsulation. The extensions 154, 156 may also have generally smooth, rounded edges. A first elongate extension 154 extends in a direction generally opposite from the second and third elongate extensions 156, 158. The compliant brace is made of a malleable, compliant material. In particular, the three elongate extensions must be capable of being bent or shaped by the physician to comply with the shape of the local bone geometry. Materials used to make the compliant brace include, but are not limited to, titanium or stainless steel. The material used must be flexible and capable of being shaped to tightly conform to and engage the cortical surface of the bone structure despite surface irregularities that are present on the surface, even after grinding or filing to remove the irregularities. Therefore, in addition to the elongate implant 100, the compliant brace 150 provides an additional load-bearing structure for this dental prosthetic. Alternatively, the cortical bone engagement device or compliant brace may contain a fourth or fifth elongate extension (not shown). The compliant brace will have an elastic property that will allow the structure to conform to and engage the bone and form a tight seal against the bone, rather than only engaging the soft tissue surrounding the bone. By forming a tight seal, the compliant brace (1) helps reduce the chances of bacterial infiltration between the implant and the bone, and (2) reduces the amount of movement between the bone and implant, thereby promoting osseointegration.

FIG. 11 depicts an exploded view of assembly 120 with cortical bone engagement device or compliant brace 150 located between generally elongated region of the abutment 114 and elongate implant 100. Generally planar portion 152 lies in a plane perpendicular to the axis of assembly 120. Cortical bone engagement device or compliant brace 150 is coupled to assembly 120 by threading the threaded region 112 of abutment 110 through generally circular opening 153 into second threaded region 104 of elongate implant 100.

FIG. 12 depicts assembly 120 with compliant brace 150 implanted into a simulated jaw bone cross section of an anterior portion of the jaw bone. Compliant elongate extensions 154, 156, 158 mechanically link elongate implant 100 and abutment 110 to the stiff cortical bone that comprises the exterior part of the jaw bone. In addition to allowing for excellent conformance with the cortical bone, elongate extensions 154, 156, 158 provide a relatively small barrier between the teeth and the soft tissue and allow for the bone and tissue to grow back together, thereby allowing the gingivae surrounding the tooth to grow around elongate extensions 154, 156, 158 and reattach to the jaw bone. Furthermore, any one of elongate extensions 154, 156, 158 may further have a hole 160 along the length of or at the end of the extension. As seen in FIG. 12, hole 160 would optionally allow a bone tack to be placed through the elongate extension and into the bone for further attachment security. Alternatively, any one of the elongate extensions or the generally planar portion may further contain anchoring elements such as a barb (not shown) capable of securing the compliant brace to the horizontal and/or vertical surfaces of the cortical bone structure.

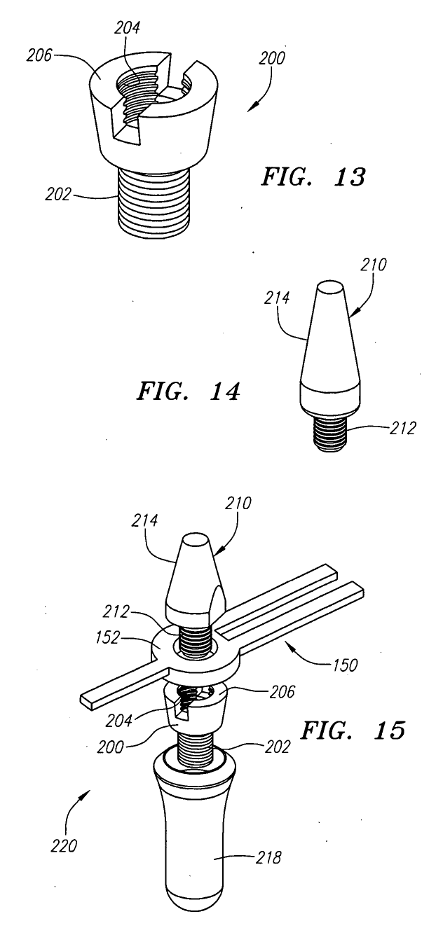

In an alternative design, as seen in FIG. 13, an adaptor 200 can be used to provide a compatible threaded interface between an abutment and an off-the-shelf implant, such as a Straumann implant. Adaptor 200 has first threaded region 202 on the outside of the adaptor capable of engaging the threaded region of an off-the-shelf implant, such as a Straumann implant. Second threaded region 204, which is located on the inside of adaptor 200, is a female joint adapted to receive and secure a threaded portion of an abutment. Adaptor 200 also has a flattened region 206 on the top of adaptor 200.

FIG. 14 depicts an alternative abutment 210 adapted to be mechanically coupled to adaptor 200. Abutment 210 has a generally elongated region 214 connected to a threaded region 212. In one embodiment, the elongated region 214 may have a conical shape. Abutment 210 may also have at least one flattened region (not shown) of the generally elongated region 214. Alternatively, abutment 210 may have at least two flattened regions of the generally elongated region 214 (not shown). Threaded region 212 is adapted to be coupled to adaptor 200 by joining threaded region 212 (male joint) of abutment 210 with second threaded region 204 of adaptor 200. Alternatively, adaptor 200 may have a threaded male joint that is adapted to be coupled with a threaded female joint of the abutment (not shown).

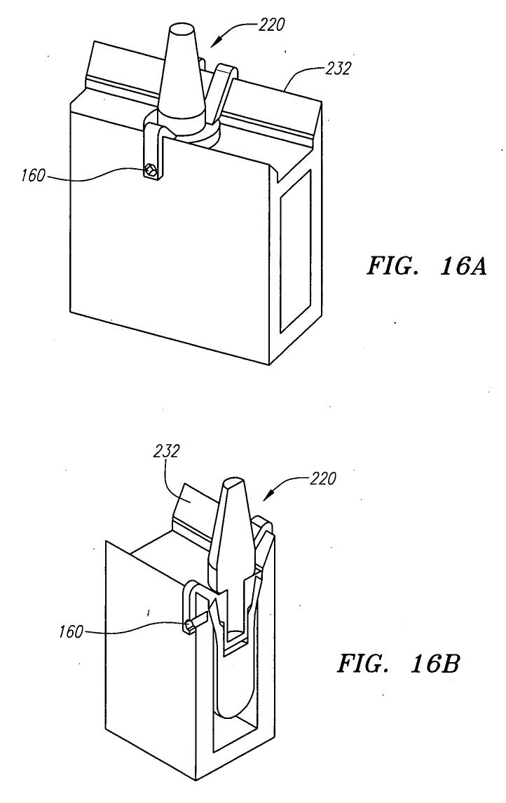

FIG. 15 depicts an exploded view of an implant assembly 220 in which an elongate implant 218, preferably an off-the-shelf implant 218 such as a Straumann adaptor, is coupled to an adaptor 200 in which first threaded region 202 is engaged with a threaded region on the interior of elongate implant 218. Abutment 210 is coupled to adaptor 200 by engaging threaded region 212 of abutment 210 with second threaded region 204 of adaptor 200. Cortical bone engagement device or compliant brace 150 is located generally between generally elongated region 214 of abutment 210 and flattened top region 206 of the adaptor. Generally planar portion 152 lies on top of flattened top region 206 in a plane perpendicular to the axis of elongate implant 218 and abutment 210. The compliant brace is coupled to abutment 210 and adaptor 200 by threading threaded region 212 of abutment 210 through generally circular opening 153 into second threaded region 204 of adaptor 200. FIGS. 16A-B depict assembly 220 implanted into a simulated jaw bone cross section 232 of an anterior portion of a jaw bone. The compliant elongate extensions 154, 156, 158 mechanically link elongate implant 218, adaptor 200, and abutment 210 to the stiff cortical bone that comprises the exterior part of the jaw bone. In addition to allowing for excellent conformance with the cortical bone, elongate extensions 154, 156, 158 provide a relatively small barrier between the teeth and the soft tissue and allow for the bone and tissue to grow back together, thereby allowing the gingivae surrounding the tooth to grow around elongate extensions 154, 156, 158 and reattach to the jaw bone. Furthermore, any one of elongate extensions 154, 156, 158 may further contain a hole 160 at the end of the extension that is farthest from generally planar portion 152. As seen in FIG. 16B, hole 160 would optionally allow a bone tack to be placed through the finger and into the bond for further attachment security. Alternatively, any one of the elongate extensions or the generally planar portion may further contain anchoring elements (not shown) capable of securing the compliant brace to the horizontal and/or vertical surfaces of the cortical bone structure.

Although the foregoing invention has, for the purposes of clarity and understanding, been described in some detail by way of illustration and example, it will be obvious that certain changes and modifications may be practiced which will still fall within the scope of the appended claims. It will also be understood that any feature or features from any one embodiment, or any reference cited herein, may be used with any combination of features from any other embodiment.

What is claimed is:

1. A dental prosthetic, comprising:
an elongate threaded implant adapted to be secured within the trabecular region of a maxilla or mandible;
an abutment having a first region adapted to receive a crown and a second region adapted for coupling to the elongate threaded implant; and
a compliant brace adapted for placement between the first region of the abutment and the elongate threaded implant, wherein the compliant brace comprises first, second, and third elongate extensions capable of engaging the cortical region of the maxilla or mandible.

2. The dental prosthetic of claim 1, wherein the compliant brace is made from a material selected from the group consisting of titanium and stainless steel.

3. The dental prosthetic of claim 1, wherein the compliant brace further comprises a generally planar region and wherein the second and third elongate extensions extend from the generally planar region in a direction substantially opposite from the first elongate extension.

4. The dental prosthetic of claim 3, wherein the generally planar region has an outer region that is generally circular in shape.

5. The dental prosthetic of claim 3, wherein the generally planar region has generally smooth, rounded edges.

6. The dental prosthetic of claim 3, wherein the compliant brace further comprises a generally circular opening in the generally planar region.

7. The dental prosthetic of claim 6, wherein the second region of the abutment is adapted for insertion through the generally circular opening of the compliant brace to secure the compliant brace to the abutment.

8. The dental prosthetic of claim 1, wherein at least one of the first, second, or third elongate extensions further comprises an anchoring element adapted to secure the first, second, or third elongate extension to the cortical region of the maxilla or mandible.

9. The dental prosthetic of claim 1, wherein at least one of the first, second, or third elongate extensions has a hole.

10. The dental prosthetic of claim 9, wherein at least one of the first, second, or third elongate extensions further comprises a bone tack adapted to be inserted through the hole.

11. The dental prosthetic of claim 1, wherein at least one of the first, second, or third elongate extensions has generally smooth, rounded edges.

12. A dental prosthetic, comprising:
an elongate threaded implant having a proximal end and a distal end and adapted to be secured within the trabecular region of a maxilla or mandible;
an adaptor having first and second regions, the first region adapted for coupling with the elongate threaded implant;
an abutment having a first region adapted to receive a crown and a second region adapted for coupling to the second region of the adaptor; and
a compliant brace located between the first region of the abutment and the adaptor, wherein the compliant brace comprises first, second, and third elongate extensions capable of engaging the cortical region of the maxilla or mandible.

13. The dental prosthetic of claim 12, wherein the compliant brace is made from a material selected from the group consisting of titanium and stainless steel.

14. The dental prosthetic of claim 12, wherein the compliant brace further comprises a generally planar region and wherein the second and third elongate extensions extend from the generally planar region in a direction substantially opposite from the first elongate extension.

15. The dental prosthetic of claim 14, wherein the generally planar region has an outer region that is generally circular in shape.

16. The dental prosthetic of claim 14, wherein the generally planar region has generally smooth, rounded edges.

17. The dental prosthetic of claim 14, wherein the compliant brace further comprises a generally circular opening in the generally planar region.

18. The dental prosthetic of claim 17, wherein the second region of the abutment is adapted for insertion through the generally circular opening of the compliant brace to secure the compliant brace to the adaptor.

19. The dental prosthetic of claim 12, wherein at least one of the first, second, or third elongate extensions further comprises an anchoring element adapted to secure the first, second, or third elongate extension to the cortical region of the maxilla or mandible.

20. The dental prosthetic of claim 12, wherein at least one of the first, second, or third elongate extensions has a hole.

21. The dental prosthetic of claim 20, wherein at least one of the first, second, or third elongate extensions further comprises a bone tack adapted to be inserted through the hole.

22. The dental prosthetic of claim 12, wherein at least one of the first, second, or third elongate extensions has generally smooth, rounded edges.

23. A method for replacing a tooth, comprising the steps of:
inserting an elongate threaded implant into position within the trabecular region of the maxilla or mandible;
securing an abutment and compliant brace to the elongate threaded implant, wherein the compliant brace has first, second, and third elongate extensions, and wherein a portion of the abutment extends beyond the maxilla or mandible;
adjusting the first, second, and third elongate extensions to engage the surface of the cortical region of the maxilla or mandible; and
securing a crown to the abutment.

24. The method of claim 23, further comprising the step of anchoring at least one of the first, second, or third elongate extensions to the maxilla or mandible.

25. The method of claim 24, wherein at least one of the first, second, or third elongate extensions is anchored to the maxilla or mandible with a bone tack.

26. The method of claim 23, wherein the adjusting step is accomplished by bending the first, second, and third elongate extensions.

27. The method of claim 23, wherein the abutment and compliant brace are secured to the elongate threaded implant by screwing a threaded region of the abutment through an opening of the compliant brace into a threaded region of the elongate threaded implant.

28. A method for replacing a tooth, comprising the steps of:
inserting an elongate threaded implant into position within the trabecular region of the maxilla or mandible;
securing an adaptor to the elongate threaded implant;
securing an abutment and compliant brace to the adaptor, wherein the compliant brace has first, second, and third elongate extensions, and wherein a portion of the abutment extends beyond the maxilla or mandible;
adjusting the first, second, and third elongate extensions to engage the surface of the cortical region of the maxilla or mandible; and
securing a crown to the abutment.

29. The method of claim 28, further comprising the step of anchoring at least one of the first, second, or third elongate extensions to the maxilla or mandible.

30. The method of claim 29, wherein at least one of the first, second, or third elongate extensions is anchored to the maxilla or mandible with a bone tack.

31. The method of claim 28, wherein the adjusting step is accomplished by bending the first, second, and third elongate extensions.

32. The method of claim 28, wherein the abutment and compliant brace are secured to the elongate threaded implant by screwing a threaded region of the abutment through an opening of the compliant brace into a threaded region of the elongate threaded implant.
